(19) United States
(12) Patent Application Publication
(10) Pub. No.: US 2025/0200907 A1
(43) Pub. Date: Jun. 19, 2025

(54) INFORMATION PROCESSING APPARATUS CAPABLE OF POSITIVELY GRASPING SOUND IN REAL SPACE, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: SEISHIRO IWAHORI, Tochigi (JP)

(21) Appl. No.: 18/977,143

(22) Filed: Dec. 11, 2024

(30) Foreign Application Priority Data
Dec. 15, 2023 (JP) 2023-212039

(51) Int. Cl. G06T 19/00; H04S 7/00

(52) U.S. Cl. CPC G06T 19/006; H04S 7/303; G06T 2219/004

(57) ABSTRACT

An information processing apparatus capable of more positively grasping a sound in a real space. User information concerning a user who visually recognizes a space image including at least an image of a virtual space is acquired. Virtual object information concerning a virtual object in the space image is acquired. In a case where a sound is generated in a real space, position information of a sound source of the generated sound is acquired. A notification method of notifying the user of a direction of the sound source in the real space is determined based on the acquired user information, the acquired virtual object information, and the acquired position information.

### BACKGROUND OF THE INVENTION

### Field of the Invention

The present invention relates to an information processing apparatus capable of positively grasping sound in a real space, a method of controlling the information processing apparatus, and a storage medium.

### Description of the Related Art

In recent years, there has been developed a technique that makes it possible to experience a space including a real space and a virtual space, represented e.g. by augmented reality (AR) and mixed reality (MR). For example, a head mounted display (HMD) used in a state attached to a head enables a user to experience a mixed space generated by superimposing a virtual object on a video image of the real space in front of eyes of the user wearing the HMD. Further, the HMDs include one capable of acquiring user's motion and motion of the sight line of a user. In this case, the HMD can synchronize the user's motion and the movement of the sight line of the user with those in the mixed space. With this, the user can obtain a high sense of immersion in the mixed space. Further, the HMDs include one that improves the sense of immersion by generating sounds. For example, U.S. Unexamined Patent Application Publication No. 2019/0314719 discloses an apparatus that analyzes voices in a real space to detect a person speaking in the real space.

However, in the apparatus described in U.S. Unexamined Patent Application Publication No. 2019/0314719, all sounds in the real space are notified to a user, and hence the user can feel troublesome. Further, in a case where sounds in a mixed space are also heard, it is difficult to judge whether a sound heard by the user is a sound in the real space or a sound in the mixed space. Further, in a case where the user has made misjudgment, i.e. in a case where a sound heard by the user is a sound in the real space but is judged to be a sound in the mixed space, the user can miss the sound in the real space.

### SUMMARY OF THE INVENTION

The present invention provides an information processing apparatus capable of more positively grasping that a heard sound is a sound in a real space, a method of controlling the information processing apparatus, and a storage medium.

In a first aspect of the present invention, there is provided an information processing apparatus, including one or more processors and/or circuitry configured to acquire user information concerning a user who visually recognizes a space image including at least an image of a virtual space, acquire virtual object information concerning a virtual object in the space image, acquire, in a case where a sound is generated in a real space, position information of a sound source of the generated sound, and determine a notification method of notifying the user of a direction of the sound source in the real space, based on the acquired user information, the acquired virtual object information, and the acquired position information.

In a second aspect of the present invention, there is provided a method of controlling an information processing apparatus that processes information, including acquiring user information concerning a user who visually recognizes a space image including at least an image of a virtual space, acquiring virtual object information concerning a virtual object in the space image, acquiring, in a case where a sound is generated in a real space, position information of a sound source of the generated sound, and determining a notification method of notifying the user of a direction of the sound source in the real space, based on the acquired user information, the acquired virtual object information, and the acquired position information.

According to the present invention, it is possible to more positively grasp that a heard sound is a sound in a real space.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an information processing apparatus according to a first embodiment.

FIG. 2 is a block diagram showing an example of a software configuration (functional configuration) of the information processing apparatus shown in FIG. 1.

FIGS. 3A and 3B are diagrams useful in explaining an example of a notification method of notifying a user of a direction of a sound source.

FIG. 4 is a flowchart of a process performed by the information processing apparatus.

FIG. 5 is a diagram showing an example of a table of a data structure stored in a user information storage section.

FIG. 6 is a diagram showing an example of a table of a data structure stored in a virtual object information storage section.

FIG. 7 is a block diagram showing an example of a software configuration (functional configuration) of the information processing apparatus according to a second embodiment.

FIG. 8 is a diagram showing an example of a table of a data structure stored in a user motion information storage section.

FIG. 9 is a flowchart of a process performed by the information processing apparatus.

### DESCRIPTION OF THE EMBODIMENTS

The present invention will now be described in detail below with reference to the accompanying drawings showing embodiments thereof. The following description of the configurations of the embodiments is given by way of example, and the scope of the present invention is not limited to the described configurations of the embodiments. For example, components of the configuration of the embodiments can be replaced by desired components which can exhibit the same function. Further, desired components can be added. Further, two or more desired components (features) of the embodiments can be combined.

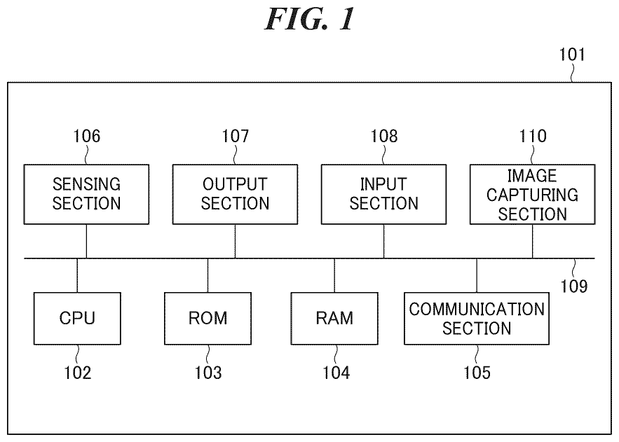

A first embodiment will be described below with reference to FIGS. 1 to 6. FIG. 1 is a block diagram showing an example of a hardware configuration of an information processing apparatus according to the first embodiment. As shown in FIG. 1, the information processing apparatus, denoted by reference numeral 101, includes a central processing unit (CPU) 102, a read only memory (ROM) 103, and a random access memory (RAM) 104. Further, the information processing apparatus 101 includes a communication section 105, a sensing section 106, an output section 107, an input section 108, and an image capturing section 110. These hardware components included in the information processing apparatus 101 are communicably interconnected via a bus 109. The CPU 102 is a computer that controls the information processing apparatus 101. The operations of the information processing apparatus 101 can be realized by programs loaded into the ROM 103 and the RAM 104. The programs include a program for causing the CPU 102 to execute a method of controlling the components and means of the information processing apparatus 101 (method of controlling the information processing apparatus), and so forth. Further, the RAM 104 is also used as a work memory for temporarily storing data for processing operations executed by the CPU 102.

Note that the number of provided CPUs 102 is one in the configuration shown in FIG. 1 but is not limited to this, and the CPU 102 can be provided in plurality. Further, in the information processing apparatus 101, in a case where the RAM 104 is used as a primary storage area, a secondary storage area, and a tertiary storage area can be further provided. The secondary storage area and the tertiary storage area are not particularly limited, and for example, a hard disk drive (HDD), a solid state drive (SSD), or the like can be used. The method of connecting the hardware components included in the information processing apparatus 101 is not limited to interconnection via the bus 109 but can be, for example, multi-stage connection. The information processing apparatus 101 can further include e.g. a graphics processing unit (GPU).

The communication section 105 is an interface for communicating with an external apparatus. The sensing section 106 acquires, for example, sight line information of a user in a real space and acquires data for determining whether or not to notify a user of e.g. sound in the real space. The output section 107 is implemented e.g. by a liquid crystal display. With this, the output section 107 functions as displaying means for displaying a variety of images and displaying, in a case where a sound is generated in the real space, e.g. a direction of the sound. Note that images displayed on the output section 107 are not particularly limited, and, for example, include an image in the real space, an image in a virtual space, and an image in a mixed space including an image in the real space and an image in the virtual space, but, in the present embodiment, it is assumed that an image in the mixed space is displayed on the output section 107. With this, the user can experience the MR. The input section 108 is implemented e.g. by a plurality of microphones each having directivity. With this, the input section 108 functions as sound collecting means for collecting, in a case where sound is generated in the real space, the generated sound. In the present embodiment, the information processing apparatus 101 is an HDM which is removably attached to the head of a user using the information processing apparatus 101. Note that the information processing apparatus 101 is not limited to the HMD but can be e.g. a desktop-type or laptop-type personal computer, a tablet terminal, or a smartphone, which is equipped with a web camera.

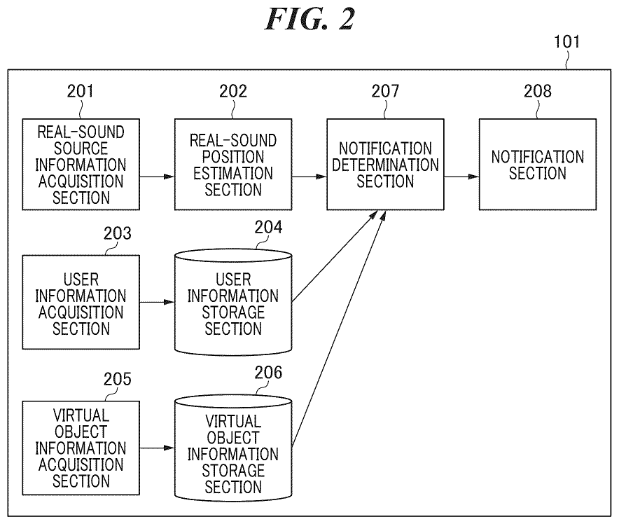

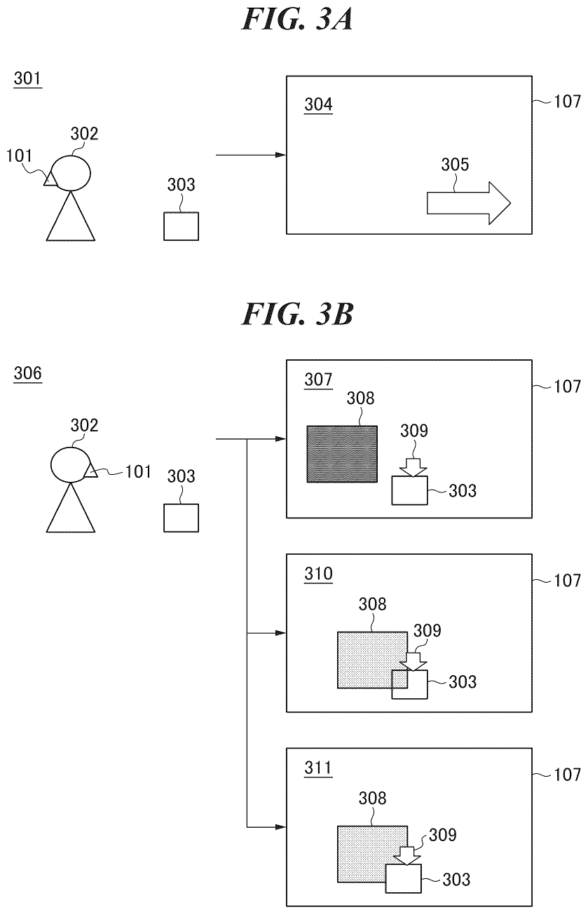

FIG. 2 is a block diagram showing an example of a software configuration (functional configuration) of the information processing apparatus shown in FIG. 1. As shown in FIG. 2, the information processing apparatus 101 includes a real-sound source information acquisition section 201 and a real-sound position estimation section (third acquisition unit) 202. The information processing apparatus 101 includes a user information acquisition section (first acquisition unit) 203 and a user information storage section 204. Further, the information processing apparatus 101 includes a virtual object information acquisition section (second acquisition unit) 205 and a virtual object information storage section 206. Further, the information processing apparatus 101 includes a notification determination section (determination unit) 207 and a notification section (notification unit) 208. The real-sound source information acquisition section 201 acquires, in a case where sound is generated from a sound source 303 (see FIG. 3A) in the real space, the sound which has been generated from the sound source 303 and collected by the input section 108 as sound data (sound information). The real-sound position estimation section 202 estimates a position of the sound source 303 based on the sound data (sound collected by the input section 108) acquired by the real-sound source information acquisition section 201 and acquires a result of the estimation as position information of the sound source 303. The method of estimating the position of the sound source 303 is not particularly limited, and for example, there can be mentioned a method of estimating the position of the sound source 303 based on differences in timing of receiving the sound from the sound source 303, which is received by the plurality of microphones forming the input section 108.

The user information acquisition section 203 acquires user information concerning a user wearing the HMD, i.e. a user who visually recognizes a space image output on the output section 107. The user information is not particularly limited, and for example, at least one of position information of a user, sight line information of the user, and gesture information concerning a gesture of the user is included. The position information of a user can be acquired by the user information acquisition section 203 e.g. based on information obtained from the global positioning system (GPS) (not shown). The sight line information of a user can be acquired by the user information acquisition section 203 e.g. based on information obtained from a detection section (not shown) for detecting a line of sight of a user. The gesture information of a user can be acquired by the user information acquisition section 203 e.g. based on information obtained from a motion capture (not shown). Then, the user information acquired by the user information acquisition section 203 is stored in the user information storage section 204.

The virtual object information acquisition section 205 acquires virtual object information concerning a virtual object 308 (see FIG. 3B) displayed e.g. by computer graphics (CG) in the space image. The virtual object information includes at least one of position information, a size, and a posture (inclination) of the virtual object 308 in the space image. Then, the virtual object information acquired by the virtual object information acquisition section 205 is stored in the virtual object information storage section 206.

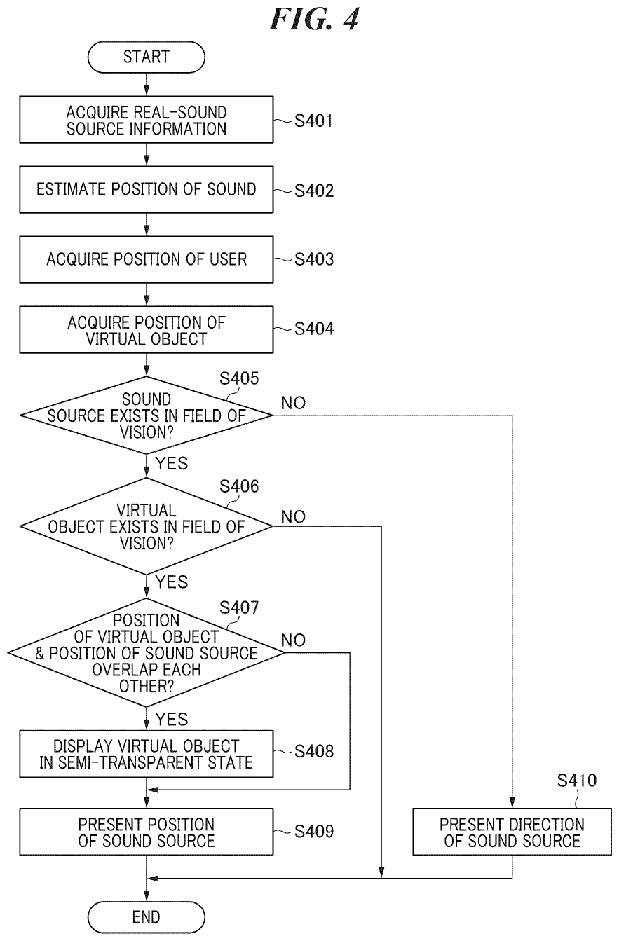

The notification determination section 207 determines a notification method (notification method) of notifying a user of the direction of the sound source 303 in the real space. This determination is performed based on the position information of the sound source 303, which has been estimated by the real-sound position estimation section 202, the user information stored in the user information storage section 204, and the virtual object information stored in the virtual object information storage section 206. Note that the determination of the notification method, which is performed by the notification determination section 207, will be described hereinafter with reference to FIG. 4. The notification section 208 notifies the user of the direction of the sound source 303 based on a result of the determination performed by the notification determination section 207, i.e. by using the notification method determined by the notification determination section 207.

FIGS. 3A and 3B are diagrams useful in explaining an example of the notification method of notifying a user of a direction of a sound source. A diagram on the left side in FIG. 3A shows a state of a real space 301. As shown in the diagram on the left side in FIG. 3A, a user 302 wearing the HMD implemented by the information processing apparatus 101 and the sound source 303 which has output sound exist in the real space 301. The user 302 faces in a direction opposite from the sound source 303. In this state, the sound source 303 is positioned outside the field of vision of the user 302. A diagram on the right side in FIG. 3A shows a space image displayed on the output section 107 of the information processing apparatus 101 in the state shown in the diagram on the left side in FIG. 3A. The user 302 can visually recognize this space image. As shown in the diagram on the right side in FIG. 3A, an arrow (marker) 305 displayed by CG is included in the space image denoted by reference numeral 304. The arrow 305 is an image for notifying the user 302 of the direction of the sound source 303. With this, the user can grasp that the sound source 303 exists in the direction indicated by the arrow 305, i.e. that the user can visually recognize the sound source 303 by turning toward the direction indicated by the arrow 305. Note that in a case where the sound source 303 is not included in the space image 304, the arrow 305 is preferably an arrow having a length proportional to a distance to the sound source 303. For example, when a case where the distance to the sound source 303 is 3 m and a case where the distance to the sound source 303 is 30 m are compared, the length of the arrow 305 can be made longer in the latter case than in the former case. This enables the user to determine whether the sound source 303 is relatively close or relatively far. Note that although the arrow 305 is used as the marker for notifying the user of the direction of the sound source 303, this is not limitative, and for example, a character string or the like indicating the direction of the sound source 303 can be used.

A diagram on the left side in FIG. 3B shows a state of a real space 306. As shown in the diagram on the left side in FIG. 3B, the user 302 and the sound source 303 exist in the real space 306. The user 302 faces toward the sound source 303. In this state, the sound source 303 is positioned within the field of vision of the user 302. A diagram in upper part, a diagram in middle part, and a diagram in lower part on the right side in FIG. 3B each show a space image displayed on the output section 107 of the information processing apparatus 101 in the state shown in the diagram on the left side in FIG. 3B. The user 302 can visually recognize one of these space images. As shown in the diagram in the upper part on the right side in FIG. 3B, the sound source 303, and a virtual object 308 and an arrow 309, displayed by CG, are included in the space image denoted by reference numeral 307. The arrow 309 is an image for notifying the user 302 of the direction of the sound source 303. The front end of the arrow 309 is in contact with the sound source 303. This makes it possible to indicate the sound source 303 with the arrow 309. With this, the user can grasp that an object indicated by the arrow 309 is the sound source 303. In the space image 307, the sound source 303 and the virtual object 308 are arranged in a state separated from each other. Note that the virtual object 308 is not particularly limited and can be e.g. an avatar of the user 302, an image of a building, or an image of a moving body, such as a vehicle.

The space image denoted by reference numeral 310 in the middle part on the right side in FIG. 3B includes the sound source 303, the virtual object 308, and the arrow 309. This space image 310 is the same as the space image 307 except that a positional relationship between the sound source 303 and the virtual object 308 is different. In the space image 310, the sound source 303 and the virtual object 308 overlap each other, and the virtual object 308 is positioned before the sound source 303. In this case, it is preferable to adjust the transmittance of the virtual object 308 to display the virtual object 308 in a semi-transparent state. With this, for example, in a case where the virtual object 308 is a moving body, even when the virtual object 308 passes in front of the sound source 303, it is possible to prevent the sound source 303 from being hidden by the virtual object 308.

The space image denoted by reference numeral 311 in the lower part on the right side in FIG. 3B includes the sound source 303, the virtual object 308, and the arrow 309. This space image 311 is the same as the space image 310 except that the positional relationship between the sound source 303 and the virtual object 308 is different. In the space image 311, the sound source 303 and the virtual object 308 overlap each other, and the virtual object 308 is positioned behind the sound source 303. For example, in a case where the virtual object 308 is an image of a building, the user can grasp that the sound source 303 exists before the virtual object 308.

FIG. 4 is a flowchart of a process performed by the information processing apparatus. The process in FIG. 4 is executed when the input section 108 of the information processing apparatus 101 receives sound from the sound source 303 in the real space. As shown in FIG. 4, in a step S401, the real-sound source information acquisition section 201 acquires sound data (sound source information) from the sound source 303, which has been received by the input section 108.

In a step S402, the real-sound position estimation section 202 estimates the position of the sound source 303 based on the sound data acquired in the step S401. A result of this estimation is used as the position information of the sound source 303. Note that it is preferable that the real-sound position estimation section 202 acquires the position information of the sound source 303 in a case where the level of the sound generated in the real space is equal to or higher than a threshold value (equal to or higher than a predetermined value). This makes it possible to narrow down all sounds in the real space to sounds to be notified in a step S409 or S410. Note that the threshold value can be changed as required. Further, the real-sound position estimation section 202 can acquire the position information of the sound source 303 in a case where the sound generated in the real space is a predetermined type of sound. This also makes it possible to narrow down all sounds in the real space to sounds from which the position and direction of a sound source is to be notified in the step S409 or S410. Further, in the step S402, the position of the sound source can be identified by using estimation of the type of the sound source, which is performed by machine learning, and an image analysis technique performed on a video based on a user's viewpoint. In this case, a waveform and a frequency of the sound are acquired.

In a step S403, the user information acquisition section 203 acquires the position information of the user as the user information. Then, the user information acquisition section 203 stores this user information in the user information storage section 204.

In a step S404, the virtual object information acquisition section 205 acquires the position information, the size, and the posture of the virtual object 308, as the virtual object information. Then, the virtual object information acquisition section 205 stores these items of virtual object information in the virtual object information storage section 206.

In a step S405, the notification determination section 207 determines (judges) whether or not the sound source 303 exists (is included) in the field of vision of the user, i.e. in an angle of view (space image) which is an image capturing range within which an image can be captured by the image capturing section 110. This determination is performed based on the position information of the sound source 303, which has been estimated in the step S402, and the position information of the user, which has been stored in the user information storage section 204 in the step S403. Then, if it is determined in the step S405 that the sound source 303 exists in the field of vision of the user, the process proceeds to a step S406. On the other hand, if it is determined in the step S405 that the sound source 303 does not exist in the field of vision of the user, the process proceeds to a step S410.

In the step S406, the notification determination section 207 determines whether or not the virtual object 308 exists in the field of vision of the user. This determination is performed based on the position information of the user, which has been stored in the user information storage section 204 in the step S403, and the virtual object information stored in the virtual object information storage section 206 in the step S404. Then, if it is determined in the step S406 that the virtual object 308 exists in the field of vision of the user, the process proceeds to a step S407. On the other hand, if it is determined in the step S406 that the virtual object 308 does not exist in the field of vision of the user, the present process is terminated.

In the step S407, the notification determination section 207 determines whether or not the virtual object 308 and the sound source 303 overlap each other in the field of vision of the user. This determination is performed based on the position information of the sound source 303, which has been estimated in the step S402. Then, if it is determined in the step S407 that he virtual object 308 and the sound source 303 overlap each other, the process proceeds to a step S408. Further, if it is determined that the virtual object 308 and the sound source 303 overlap each other, the notification determination section 207 also determines a front-rear relationship between the virtual object 308 and the sound source 303. Here, it is assumed, by way of example, that the virtual object 308 is positioned before the sound source 303. On the other hand, if it is determined in the step S407 that he virtual object 308 and the sound source 303 do not overlap each other, the process proceeds to the step S409. In the present embodiment, the notification determination section 207 also functions as determining means (determination unit) for performing the determination in the step S405, the determination in the step S406, and the determination in the step S407. Note that in the information processing apparatus 101, part which functions as the determining means can be provided separately from the notification determination section 207. Further, determination means for performing the determination operations in the steps S405 to S407 can be respectively provided.

In the step S408, the notification section 208 displays the virtual object 308 determined to be in the overlapping state in the step S407 on the output section 107 in the semi-transparent state (see the diagram in the middle part on the right side in FIG. 3B).

In the step S409, the notification section 208 displays the arrow 309 indicating the sound source 303 on the output section 107 based on the position information of the sound source 303, which has been estimated in the step S402 (see the diagram in the middle part on the right side in FIG. 3B). After execution of the step S409, the present process is terminated.

In the step S410 after execution of the step S405, the notification section 208 displays the arrow 305 orientating toward the sound source 303 on the output section 107 based on the position information of the sound source 303, which has been estimated in the step S402 (see the diagram on the left side in FIG. 3A). After execution of the step S410, the present process is terminated.

The information processing apparatus 101 capable of performing the above-described control can notify the user of the sound to be notified in the real space. This prevents all sounds in the real space from being notified to the user, and therefore, for example, it is possible to reduce the troublesome feeling of the user, which is caused by the notification of all sounds. Further, even when the user also hears a sound from the HMD, the user can accurately judge whether the sound is a sound in the real space or a sound from the HMD by checking the arrow displayed on the output section 107. Thus, in the information processing apparatus 101, it is possible to more positively grasp that the sound is a sound in the real space.

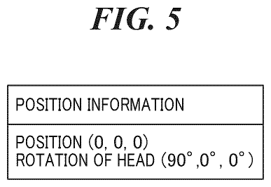

FIG. 5 is a diagram showing an example of a table of a data structure stored in the user information storage section. As shown in FIG. 5, the position information of the user is stored in the user information storage section 204. This position information includes six-degrees-of-freedom (DoF) information, i.e. the position and orientation of the head of the user, using coordinates.

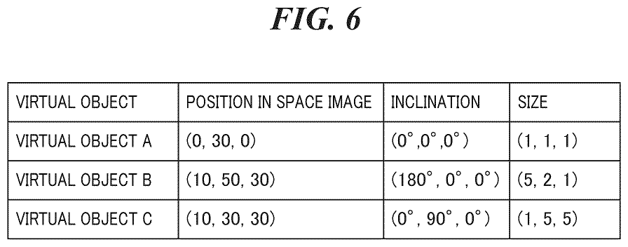

FIG. 6 is a diagram showing an example of a table of a data structure stored in the virtual object information storage section. As shown in FIG. 6, the virtual object information storage section 206 stores a name, position information, a size, and inclination of the virtual object, as the virtual object information. The position information of the virtual object is indicated by a distance from a reference position using the six-degrees-of-freedom information. The size of the virtual object is indicated by a distance from the center of the virtual object. The inclination of the virtual object indicates a rotational angle of the virtual object.

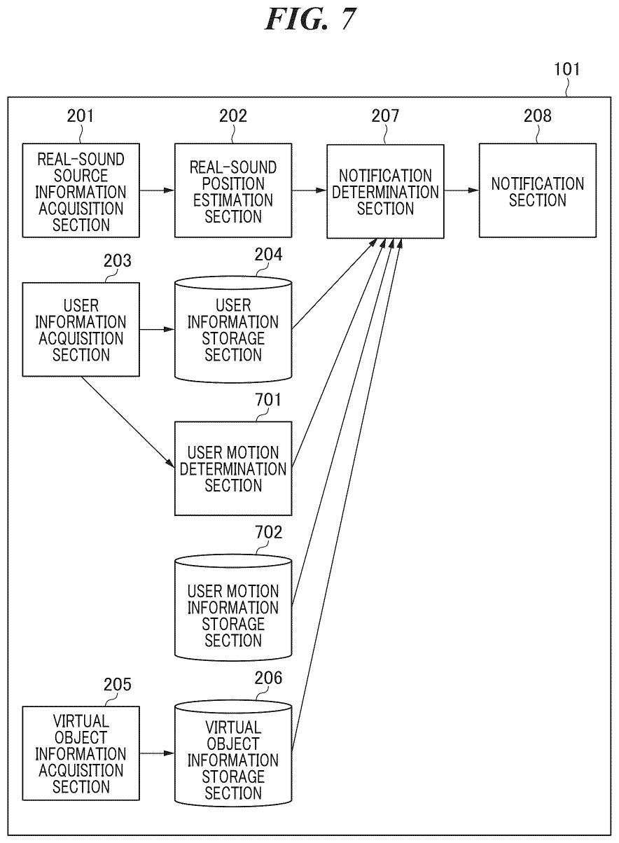

Although a second embodiment will be described below with reference to FIGS. 7 to 9, the description will be given mainly of a different point from the above-described embodiment, and description of the same points is omitted. The present embodiment is the same as the first embodiment except that whether or not to perform notification determination is determined based on a user's motion acquired when a real sound is heard. FIG. 7 is a block diagram showing an example of a software configuration (functional configuration) of the information processing apparatus according to the second embodiment. As shown in FIG. 7, the information processing apparatus 101 further includes a user motion determination section 701 and a user motion information storage section 702, in addition to the software configuration shown FIG. 2. The user motion determination section 701 determines what kind of motion the user has performed based on changes in the position information of the user, which has been acquired by the user information acquisition section 203. A result of the determination performed by the user motion determination section 701, i.e. the motion information of the user is stored in the user motion information storage section 702.

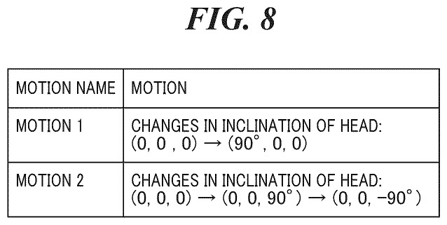

FIG. 8 is a diagram showing an example of a table of a data structure stored in the user motion information storage section. As shown in FIG. 8, gesture information as the motion information of the user is stored in the user motion information storage section 702. The gesture information includes a motion name (gesture name) and a motion (changes in the inclination of the head). For example, a motion 1 indicates a gesture that the user has looked down.

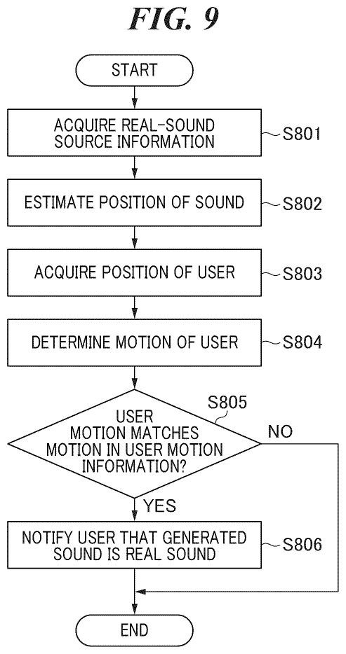

FIG. 9 is a flowchart of a process performed by the information processing apparatus. As shown in FIG. 9, in a step S801, the real-sound source information acquisition section 201 acquires sound data (sound source information) from the sound source 303, which has been received by the input section 108. This step S801 is the same as the step S401 of the flowchart in FIG. 4.

In a step S802, the real-sound position estimation section 202 estimates the position of the sound source 303, which is used as the position information of the sound source 303, based on the sound data acquired in the step S801. This step S802 is the same as the step S402.

In a step S803, the user information acquisition section 203 acquires the position information of the user as the user information and stores this user information in the user information storage section 204. This step S803 is the same as the step S403.

In a step S804, the user motion determination section 701 determines a motion of the user based on changes, i.e. temporal changes, in the position information of the user stored in the user information storage section 204 in the step S803.

In a step S805, the notification determination section 207 determines whether or not the gesture information stored in the user motion information storage section 702 in advance and the motion information of the user, which has been determined in the step S804, match each other. If it is determined in the step S805 that the gesture information and the motion information of the user match each other, the process proceeds to a step S806. On the other hand, if it is determined in the step S805 that the gesture information and the motion information of the user do not match each other, the present process is terminated. Note that although in the step S805, whether or not the gesture information and the motion information of the user match each other is determined, this is not limitative. For example, in the step S805, a captured image obtained by the image capturing section 110 can be read or a gesture of the user can be read from a controller (not shown) held by the user, and whether or not a result of this reading and the gesture information stored in advance match each other can be determined.

In the step S806, the notification section 208 displays information that the sound is a real sound on the output section 107.

With this control, even in a situation where it is relatively difficult for a user to recognize a sound in the real space, it is possible to notify the user of this sound.

The present invention has been described heretofore based on the embodiments thereof. However, the present invention is not limited to the above-described embodiments, but it can be practiced in various forms, without departing from the spirit and scope thereof. The present invention can also be accomplished by supplying a program which realizes one or more functions of the above-described embodiments to a system or an apparatus via a network or a storage medium, and causing one or more processors of a computer of the system or apparatus to read out and execute the program. Further, the present invention can also be accomplished by a circuit (such as an application specific integrated circuit (ASIC)) that realizes one or more functions. Further, although the information processing apparatus 101 is the HMD having the CPU 102 to the image capturing section 110, as the components thereof, in the embodiments, this is not limitative. For example, the sensing section 106, the output section 107, the input section 108, and the image capturing section 110 can be omitted from the information processing apparatus 101, and these components can form the HMD communicably connected to the information processing apparatus 101. In this case, the information processing apparatus 101 and the HMD can be connected by wired connection or wireless connection. Further, in this case, the information processing apparatus 101 can be configured as a server, and an information processing system can be formed by the server and the HMD.

In this information processing system, for example, even in a case where the server exists outside Japan, and the HMD as a terminal apparatus exists within Japan, each file and data can be transmitted from the server to the terminal apparatus, and the terminal apparatus can receive the file and data. Thus, even in the case where the server exists outside Japan, transmission and reception of a file and data in this system are collectively performed, i.e. performed without a separate operation performed by a user of the terminal apparatus. Further, since the system functions according to reception of each file and data by the terminal apparatus existing within Japan, it is possible to consider that the transmission/reception is performed within Japan. In this system, for example, even in a case where the server exists outside Japan, and the terminal apparatus exists within Japan, the terminal apparatus can perform the main function of this system, and further, can exhibit the effect obtained by this function within Japan. For example, even when the server exists outside Japan, if the terminal apparatus forming this system exists within Japan, it is possible to use this system within Japan by using this terminal apparatus. Further, the use of this system can have influence on the economic benefits e.g. for the patent owner.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212039 filed Dec. 15, 2023, which is hereby incorporated by reference herein in its entirety.

What is claimed is:

1. An information processing apparatus, comprising one or more processors and/or circuitry configured to:
acquire user information concerning a user who visually recognizes a space image including at least an image of a virtual space;
acquire virtual object information concerning a virtual object in the space image;
acquire, in a case where a sound is generated in a real space, position information of a sound source of the generated sound; and
determine a notification method of notifying the user of a direction of the sound source in the real space, based on the acquired user information, the acquired virtual object information, and the acquired position information.

2. The information processing apparatus according to claim 1, wherein the one or more processors and/or circuitry is/are further configured to notify the user of a direction of the sound source by using the determined notification method.

3. The information processing apparatus according to claim 1, wherein the one or more processors and/or circuitry is/are further configured to display the space image; and
wherein the notifying includes notifying the user of a direction of the sound source by using a marker displayed in the space image by the displaying.

4. The information processing apparatus according to claim 3, wherein the marker is an arrow.

5. The information processing apparatus according to claim 4, wherein the space image is an image in a mixed space, including an image in the real space and an image in the virtual space, and
wherein in a case where the sound source is included in the space image, the notifying is performed by the arrow indicating the sound source.

6. The information processing apparatus according to claim 4, wherein the space image is an image in a mixed space, including an image in the real space and an image in the virtual space, and
wherein in a case where the sound source is not included in the space image, the notifying is performed by the arrow having a length proportional to a distance to the sound source.

7. The information processing apparatus according to claim 3, wherein the space image is an image in a mixed space, including an image in the real space and an image in the virtual space, and
wherein in a case where the virtual object and the sound source are included in the space image, and the virtual object and the sound source overlap each other, the displaying is performed by adjusting transmittance of the virtual object.

8. The information processing apparatus according to claim 1, wherein the acquiring of the user information is performed by acquiring at least one of position information of the user, sight line information of the user, and information concerning a gesture of the user, as the user information.

9. The information processing apparatus according to claim 1, wherein the acquiring of the virtual object information is performed by acquiring at least one of position information, a size, and a posture of the virtual object in the space image, as the virtual object information.

10. The information processing apparatus according to claim 1, wherein the one or more processors and/or circuitry is/are further configured to collect, in a case where a sound is generated in the real space, the generated sound, and
wherein the acquiring of the position information of the sound source includes estimating a position of the sound source based on the sound collected by the collecting, and acquiring a result of the estimation as the position information.

11. The information processing apparatus according to claim 1, wherein the acquiring of the position information of the sound source includes acquiring the position information of the sound source, in a case where the level of the sound generated in the real space is equal to or higher than a predetermined level.

12. The information processing apparatus according to claim 1, wherein the acquiring of the position information of the sound source includes acquiring the position information of the sound source, in a case where the sound generated in the real space is a predetermined type of sound.

13. The information processing apparatus according to claim 1, wherein the determining of the notification method can include not notifying the direction of the sound source as the notification method.

14. The information processing apparatus according to claim 1, wherein the space image is an image in a mixed space, including an image in the real space and an image in the virtual space, and
wherein the one or more processors and/or circuitry is/are further configured to determine whether or not the sound source is included in the space image.

15. The information processing apparatus according to claim 1, wherein the space image is an image in a mixed space, including an image in the real space and an image in the virtual space, and
wherein the one or more processors and/or circuitry is/are further configured to determine whether or not the virtual object is included in the space image.

16. The information processing apparatus according to claim 1, wherein the space image is an image in a mixed space, including an image in the real space and an image in the virtual space, and
wherein the one or more processors and/or circuitry is/are also configured to determine whether or not the virtual object and the sound source are included in the space image in a state overlapping each other.

17. The information processing apparatus according to claim 1, further comprising a display unit configured to display the space image.

18. The information processing apparatus according to claim 1, wherein the information processing apparatus is a head mounted display (HMD).

19. A method of controlling an information processing apparatus that processes information, comprising:
acquiring user information concerning a user who visually recognizes a space image including at least an image of a virtual space;
acquiring virtual object information concerning a virtual object in the space image;
acquiring, in a case where a sound is generated in a real space, position information of a sound source of the generated sound; and
determining a notification method of notifying the user of a direction of the sound source in the real space, based on the acquired user information, the acquired virtual object information, and the acquired position information.

20. A non-transitory computer-readable storage medium storing a program for causing a computer to execute a method of controlling an information processing apparatus that processes information,
wherein the method comprises:
acquiring user information concerning a user who visually recognizes a space image including at least an image of a virtual space;
acquiring virtual object information concerning a virtual object in the space image;
acquiring, in a case where a sound is generated in a real space, position information of a sound source of the generated sound; and
determining a notification method of notifying the user of a direction of the sound source in the real space, based on the acquired user information, the acquired virtual object information, and the acquired position information.
